(19) United States
(12) Patent Application Publication
(10) Pub. No.: US 2023/0222597 A1
(43) Pub. Date: Jul. 13, 2023

(54) Predictive and Prescriptive Analytics for Managing High-Cost Claimants in Healthcare

(71) Applicant: International Business Machines Corporation, Armonk, NY (US)

(72) Inventors: Ramani R. Routray, San Jose, CA (US); Lixiang Zhang, State College, PA (US); Nan Liu, San Jose, CA (US); Mu Qiao, Belmont, CA (US); Yifan Hao, Foster City, CA (US); Colman Seery, Claremont, CA (US)

(21) Appl. No.: 17/572,504

(22) Filed: Jan. 10, 2022

(51) Int. Cl. G06Q 40/08; G06N 3/08; G06N 3/04

(52) U.S. Cl. CPC G06Q 40/08; G06N 3/08; G06N 3/0445

(57) ABSTRACT

A mechanism is provided in a data processing system for predictive and prescriptive analytics for managing high-cost claimants. The mechanism trains a machine learning model using the set of de-identified claims data to predict high-cost claimants using the training data. The mechanism applies transfer learning by retraining the machine learning model using a first set of customized client data to generate a client-specific machine learning model. The mechanism then applies the client-specific machine learning model to a second set of customized client data to identify a set of predicted high-cost claimants within the second set of customized client data. The mechanism generates association rules for determining recommendations for preventing the set of predicted high-cost claimants from becoming high-cost claimants and applies the association rules to the second set of customized client data to generate a set of recommendations.

### BACKGROUND

The present application relates generally to an improved data processing apparatus and method and more specifically to mechanisms for predictive and prescriptive analytics for managing high-cost claimants in healthcare.

United States healthcare spending grew 4.6% to $3.8 trillion in 2019, or $11,582 per person, and accounted for 17.7% of Gross Domestic Product (GDP), according to the Centers for Medicare and Medicaid Services (CMS). The American Health Policy Institute defines a high-cost claimant (HCC) as an individual who costs $50,000 or more annually. The group's analysis of twenty-six large employers' claims data found that the average high-cost claimant costs $122,382 each year, or 29.3 times as much as the average member. Even though they represent just 1.2% of all members, high-cost claimants make up 31% of total healthcare spending for the surveyed employers. Reducing costs for HCCs requires a focus on impactable members where intervention can yield a change in future cost, utilization, and outcome.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method is provided in a data processing system, for predictive and prescriptive analytics for managing high-cost claimants. The method comprises training a machine learning model using the set of de-identified claims data to predict high-cost claimants using the training data. The method further comprises applying transfer learning by retraining the machine learning model using a first set of customized client data to generate a client-specific machine learning model. The method further comprises applying the client-specific machine learning model to a second set of customized client data to identify a set of predicted high-cost claimants within the second set of customized client data. The method further comprises generating association rules for determining recommendations for preventing the set of predicted high-cost claimants from becoming high-cost claimants. The method further comprises applying the association rules to the second set of customized client data to generate a set of recommendations.

In another illustrative embodiment, a computer program product comprises a computer readable storage medium having a computer readable program stored therein, wherein the computer readable program, when executed on a computing device, causes the computing device to train a machine learning model using the set of de-identified claims data to predict high-cost claimants using the training data. The computer readable program further causes the computing device to apply transfer learning by retraining the machine learning model using a first set of customized client data to generate a client-specific machine learning model. The computer readable program further causes the computing device to apply the client-specific machine learning model to a second set of customized client data to identify a set of predicted high-cost claimants within the second set of customized client data. The computer readable program further causes the computing device to generate association rules for determining recommendations for preventing the set of predicted high-cost claimants from becoming high-cost claimants. The computer readable program further causes the computing device to apply the association rules to the second set of customized client data to generate a set of recommendations.

In yet another illustrative embodiment, an apparatus comprises a processor and a memory coupled to the processor, the memory comprises instructions which, when executed by the processor, cause the processor to train a machine learning model using the set of de-identified claims data to predict high-cost claimants using the training data. The instructions further cause the processor to apply transfer learning by retraining the machine learning model using a first set of customized client data to generate a client-specific machine learning model. The instructions further cause the processor to apply the client-specific machine learning model to a second set of customized client data to identify a set of predicted high-cost claimants within the second set of customized client data. The instructions further cause the processor to generate association rules for determining recommendations for preventing the set of predicted high-cost claimants from becoming high-cost claimants. The instructions further cause the processor to apply the association rules to the second set of customized client data to generate a set of recommendations.

The illustrative embodiments provide mechanisms for not only predicting likely future high-cost claimants but also generating prescriptive recommendations for preventing members from becoming high-cost claimants.

In one example embodiment, generating the association rules comprises finding frequent common features among the set of predicted high-cost claimants; filtering the de-identified claims data for individuals having the frequent common features; and applying association rule mining on the filtered de-identified claims data to generate a set of association rules, wherein each rule in the set of association rule associates a measure with an individual who is no longer a high-cost claimant. This embodiment generates rules for creating recommendations for reducing healthcare costs by mining existing claims data.

In another example embodiment, generating the association rules further comprises generating a confidence value for each measure and ranking the measures by confidence value. In yet another example embodiment, applying the association rules to the second set of customized client data comprises outputting a predetermined number of recommendations with the highest confidence value. These embodiments provide recommendations that are most likely to result in reduction in healthcare costs.

In another example embodiment, generating the association rules comprises applying a Frequent Pattern (FP) Growth algorithm to the second set of customized client data. This embodiment uses Association Rule Learning for discovering frequent items in a transaction database without any generation of candidates.

In one example embodiment, the machine learning model comprises a bidirectional Recurrent Neural Network with attention. This embodiment allows the neural network to exhibit temporal dynamic behavior and to focus on a subset of its inputs (or features).

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system in which aspects of the illustrative embodiments may be implemented;

FIG. 2 is an example block diagram of a computing device in which aspects of the illustrative embodiments may be implemented;

FIG. 3 is a block diagram illustrating an overall flow for predictive and prescriptive analytics for managing high-cost claimants in accordance with an illustrative embodiment;

FIG. 4 depicts a block diagram illustrating mechanisms for predictive analytics for identifying predicted high-cost claimants in accordance with an illustrative embodiment;

FIG. 5 is a flowchart illustrating operation of a mechanism for training and applying a predictive AI model for identifying predicted high-cost claimants in accordance with an illustrative embodiment; and

FIG. 6 is a flowchart illustrating operation of a mechanism for performing prescriptive analytics to generate recommendations to reduce healthcare costs in accordance with an illustrative embodiment.

### DETAILED DESCRIPTION

To cope with cost problems in both the private and public sectors, there is a need for better understanding of what healthcare costs lie behind high-cost claimants. According to a study published in the Journal of the American Medical Association, seven procedures account for 80% of all hospital admissions, deaths, complications, and inpatient costs from emergency room surgery. These include gallbladder removal, appendectomy, and surgery to treat ulcers. While common, these procedures are costly. National quality benchmarks and cost reduction efforts should focus these general surgery procedures. While it can be difficult for employers to address acute conditions in their employee populations, it may be helpful to know which emergency procedures may be incurred by high-cost claimants.

The illustrative embodiments provide a computer tool for predictive and prescriptive analytics using artificial intelligence and machine learning for managing high-cost claimants in healthcare. The computer tool of the illustrative embodiments provides a management strategy for HCCs using proactive identification, early intervention, and cost management that can be achieved through predictive and prescriptive analytics.

The illustrative embodiments provide a predictive and prescriptive analytics engine for identifying members who are predicted to be HCCs and to provide healthcare recommendations or early interventions to reduce healthcare cost to employers as well as insurance companies. In one embodiment, the predictive and prescriptive analytics engine applies a bidirectional recurrent neural network with attention to predict high-cost claimants. The predictive and prescriptive analytics engine infuses de-identified claims data with customized client data as input for model training. IBM® MarketScan® Research Databases provide a collection of proprietary de-identified claims data for privately and publicly insured people in the United States. The predictive and prescriptive analytics engine applies transfer learning on customized client data by retraining a common model with customized data.

The predictive and prescriptive analytics engine also performs prescriptive analytics on the combined de-identified claims data and customized client data to recommend measures to reduce costs for the identified predicted HCCs. The predictive and prescriptive analytics engine finds frequent common features among the predicted HCCs by Frequent Pattern (FP) Growth. The predictive and prescriptive analytics engine filters individuals in the historical de-identified claims data with the common features and generates association rules to determine a set of measures that lead to claimants no longer being HCCs. The predictive and prescriptive analytics engine then recommends the top measures ranked by confidence score.

FP Growth is an Association Rule Learning. FP Growth algorithm is used for discovering frequent items in a transaction database without any generation of candidates. FP Growth represents frequent item sets in frequent pattern trees which can also be called as FP-tree. In the first pass, the FP Growth algorithm counts the occurrences of items (attribute-value pairs) in the dataset of transactions and stores these counts in a “header table.” In the second pass, it builds the FP-tree structure by inserting transactions into a tree. Items in each transaction have to be sorted by descending order of their frequency in the dataset before being inserted so that the tree can be processed quickly. Items in each transaction that do not meet the minimum support requirement are discarded. If many transactions share most frequent items, the FP-tree provides high compression close to tree root. Recursive processing of this compressed version of the main dataset grows frequent item sets directly instead of generating candidate items and testing them against the entire database. Growth begins from the bottom of the header table, i.e., the item with the smallest support by finding all sorted transactions that end in that item. Call this item I. A new conditional tree is created, which is the original FP-tree projected onto I. The supports of all nodes in the projected tree are re-counted with each node getting the sum of its child counts. Nodes (and hence subtrees) that do not meet the minimum support are pruned. Recursive growth ends when no individual items conditional on I meet the minimum support threshold. The resulting paths from root to I will be frequent item sets. After this step, processing continues with the next least-supported header item of the original FP-tree. Once the recursive process has completed, all frequent item sets will have been found, and association rule creation begins.

Thus, the illustrative embodiments provide a computer tool that uses computer-specific techniques to predict HCCs from large amounts of data and to prescribe measures for ensuring the identified predicted HCCs do not become HCCs. These computer-specific techniques include artificial intelligence, machine learning, and data mining, which are techniques that cannot practically be performed in the human mind. Therefore, the illustrative embodiments configure a computer with machine learning models and association rule mining to transform the computer into a specific computer tool.

The illustrative embodiments differ from prior art solutions that ascertain risks of particular medical conditions, because the predictive and prescriptive analytics engine of the illustrative embodiments predict whether claimants will be categorized as high cost regardless of medical condition and suggests measures to reduce costs for the identified claimants. That is, the illustrative embodiments are concerned with those claimants or patients who contribute to high costs regardless of whether their medical conditions are serious, severe, or life-threatening. The predictive and prescriptive analytics engine of the illustrative embodiments can be used in conjunction with prior art healthcare cognitive systems to both improve patient health and reduce healthcare costs.

Before beginning the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular implementation for accomplishing and/or performing the actions, steps, processes, etc., attributable to and/or performed by the engine. An engine may be, but is not limited to, software executing on computer hardware, specialized computer hardware and/or firmware, or any combination thereof that performs the specified functions including, but not limited to, any use of a general and/or specialized processor in combination with appropriate software loaded or stored in a machine readable memory and executed by the processor to thereby specifically configure the processor to perform the specific functions of the illustrative embodiments. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

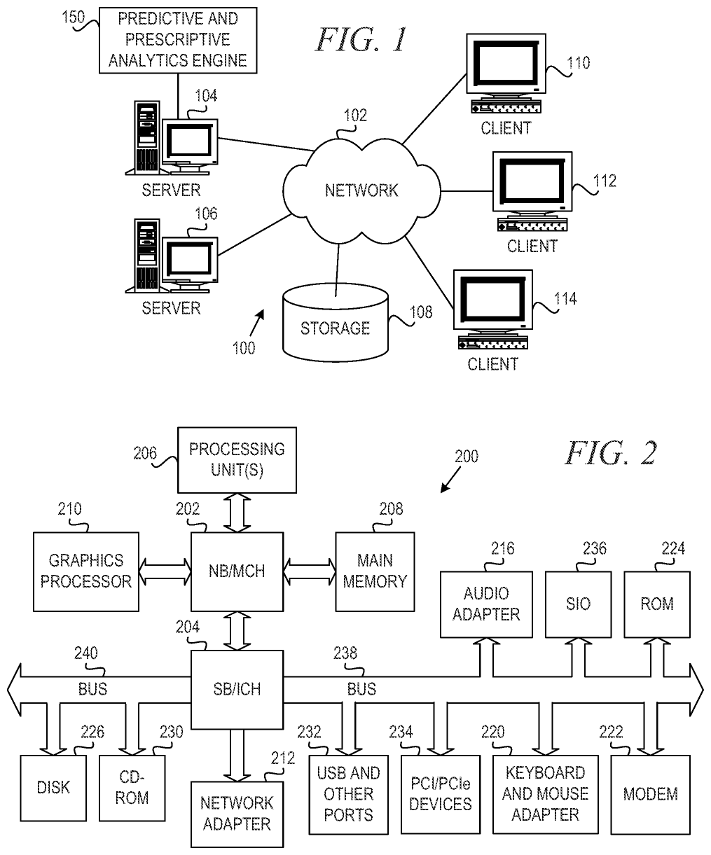

The illustrative embodiments may be utilized in many different types of data processing environments. In order to provide a context for the description of the specific elements and functionality of the illustrative embodiments, FIGS. 1 and 2 are provided hereafter as example environments in which aspects of the illustrative embodiments may be implemented. It should be appreciated that FIGS. 1 and 2 are only examples and are not intended to assert or imply any limitation with regard to the environments in which aspects or embodiments of the present invention may be implemented. Many modifications to the depicted environments may be made without departing from the spirit and scope of the present invention.

FIG. 1 depicts a pictorial representation of an example distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational, and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

As shown in FIG. 1, one or more of the computing devices, e.g., server 104, may be specifically configured to implement a predictive and prescriptive analytics engine 150. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as server 104, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general-purpose computing device. Moreover, as described hereafter, the implementation of the mechanisms of the illustrative embodiments improves the functionality of the computing device and provides a useful and concrete result that facilitates predictive and prescriptive analytics for managing high-cost claimants. A claimant is a patient or group member for which data are analyzed to predict high cost and to prescribe measures to reduce healthcare costs. That is, costs associated with patients are analyzed based on medical claims submitted by or for patients within a membership group. A claimant may be a member of a data set, a healthcare insurance group, or a group of employees. Thus, patients will also be referred to herein as claimants or members.

The predictive and prescriptive analytics engine 150 trains and applies one or more machine learning models for identifying members who are predicted to be high-cost claimants. The predictive and prescriptive analytics engine 150 also applies machine learning and association rule mining to find rules that determine a set of procedures, drugs, or rehabilitation measures that result in individual members no longer being high-cost claimants, as will be described in further detail below.

These computing devices, or data processing systems, may comprise various hardware elements which are specifically configured, either through hardware configuration, software configuration, or a combination of hardware and software configuration, to implement one or more of the systems/subsystems described herein. FIG. 2 is a block diagram of just one example data processing system in which aspects of the illustrative embodiments may be implemented. Data processing system 200 is an example of a computer, such as server 104 in FIG. 1, in which computer usable code or instructions implementing the processes and aspects of the illustrative embodiments of the present invention may be located and/or executed so as to achieve the operation, output, and external effects of the illustrative embodiments as described herein.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. In a client device, the operating system may be a commercially available operating system such as Microsoft® Windows 10®. An object-oriented programming system, such as the Java™ programming system, may run in conjunction with the operating system and provides calls to the operating system from Javar™ programs or applications executing on data processing system 200.

As a server, data processing system 200 may be, for example, an IBM eServer™ System p® computer system, Power M processor-based computer system, or the like, running the Advanced Interactive Executive (AIX®) operating system or the LINUX® operating system. Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

As mentioned above, in some illustrative embodiments the mechanisms of the illustrative embodiments may be implemented as application specific hardware, firmware, or the like, application software stored in a storage device, such as HDD 226 and loaded into memory, such as main memory 208, for executed by one or more hardware processors, such as processing unit 206, or the like. As such, the computing device shown in FIG. 2 becomes specifically configured to implement the mechanisms of the illustrative embodiments and specifically configured to perform the operations and generate the outputs described hereafter with regard to predictive and prescriptive analytics for managing high-cost claimants.

Those of ordinary skill in the art will appreciate that the hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device that is configured with flash memory to provide non-volatile memory for storing operating system files and/or user-generated data, for example. Essentially, data processing system 200 may be any known or later developed data processing system without architectural limitation.

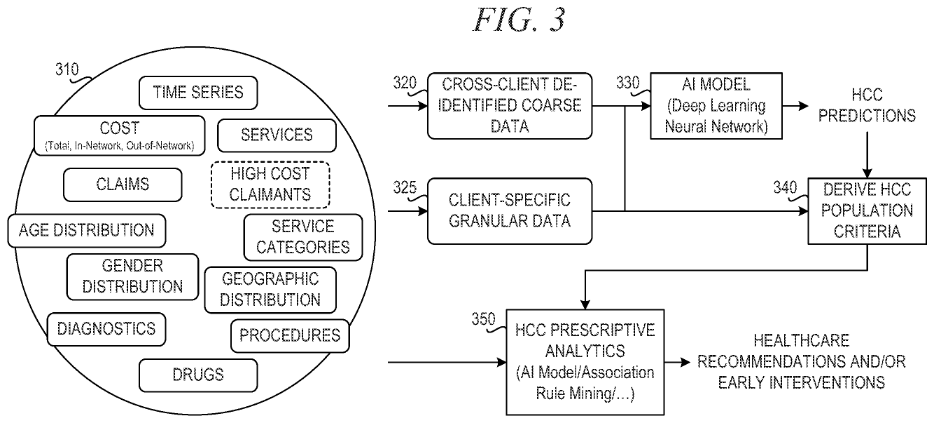

FIG. 3 is a block diagram illustrating an overall flow for predictive and prescriptive analytics for managing high-cost claimants in accordance with an illustrative embodiment. The mechanisms receive claims data 310, which include time series data, cost data, services, claims, known high-cost claimants (HCCs), age distribution, gender distribution, geographic distribution, service categories, diagnostics, procedures, and drugs. The cost data include total cost, in-network cost, and out-of-network cost. From claims data 310, the mechanisms generate cross-client de-identified coarse data 320 and client-specific granular data 325.

The mechanisms first trains artificial intelligence (AI) model 330 using cross-client de-identified coarse data 320. Then, the mechanisms apply transfer learning by retraining AI model 330 using client-specific granular data 325. AI model 330 then generates HCC predictions based on client-specific granular data 325.

The mechanisms derive HCC population criteria at block 340. Next, the mechanisms perform HCC prescriptive analytics at block 350. The HCC prescriptive analytics may include applying an AI model, association rule mining, etc. The HCC prescriptive analytics generate healthcare recommendations and/or early interventions.

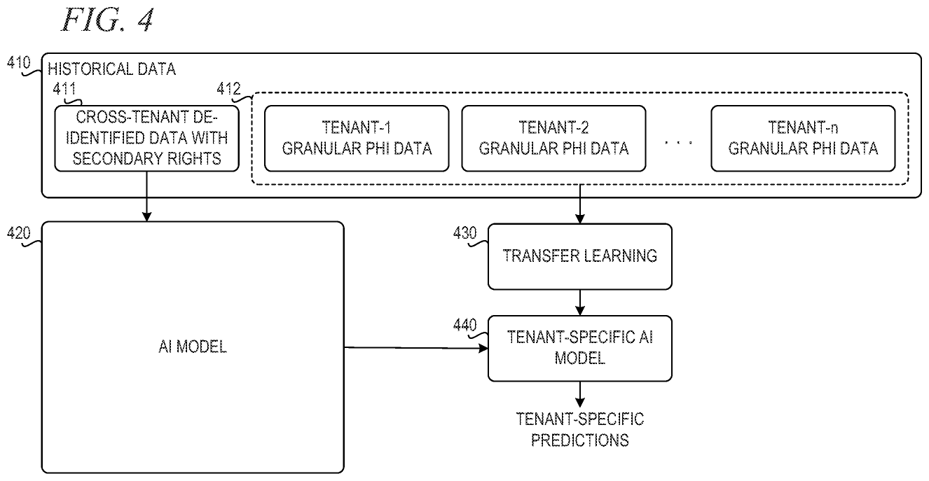

FIG. 4 depicts a block diagram illustrating mechanisms for predictive analytics for identifying predicted high-cost claimants in accordance with an illustrative embodiment. Historical data 410 includes cross-tenant de-identified data with secondary rights 411 and tenant granular protected health information (PHI) data 412, which includes granular PHI data for tenants 1 . . . n. A tenant is a representation of an organization (e.g., a company). Secondary data is the data that has already been collected through primary sources and made readily available for researchers to use for their own research. It is a type of data that has already been collected in the past.

AI model 420 is trained using cross-tenant de-identified data. Then, transfer learning 430 is applied to retrain the model using tenant granular PHI data 412 to generate tenant-specific AI model 440, which makes tenant-specific predictions. For example, AI model 420 can be used as the starting point for training tenant-specific AI model 440 using tenant granular PHI data 412. That is, AI model 420 is the base model for tenant-specific AI model 440.

In one embodiment, AI model 420 is a bidirectional recurrent neural network (Bi-RNN) with attention. A recurrent neural network (RNN) is a class of artificial neural networks where connections between nodes form a directed or undirected graph along a temporal sequence. This allows the neural network to exhibit temporal dynamic behavior. Bidirectional recurrent neural networks (Bi-RNN) connect two hidden layers of opposite directions to the same output. With this form of generative deep learning, the output layer can get information from past (backwards) and future (forward) states simultaneously. Attention configures the neural network to focus on a subset of its inputs (or features). A typical neural net is implemented as a chain of matrix multiplications and element-wise non-linearities, where elements of the input or feature vectors interact with each other only by addition. Attention mechanisms compute a mask that is used to multiply features. Using attention, the space of functions that can be well approximated by a neural network is vastly expanded.

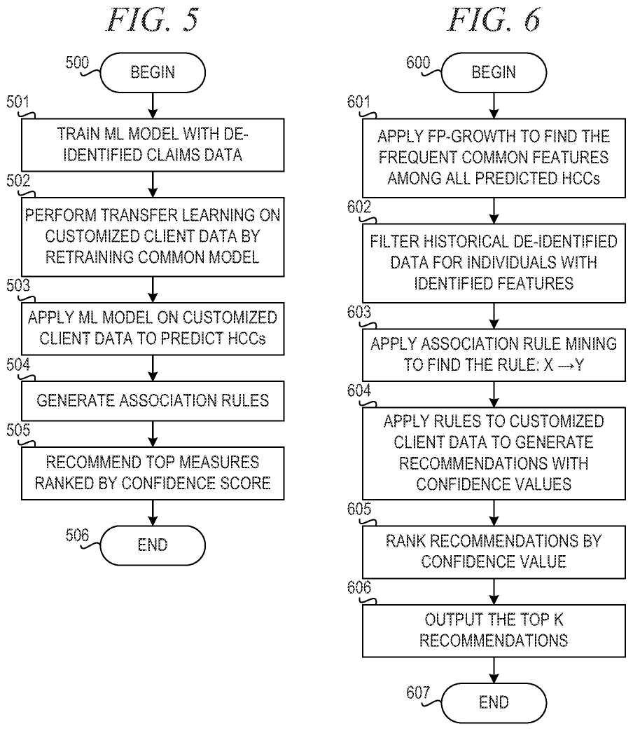

FIG. 5 is a flowchart illustrating operation of a mechanism for training and applying a predictive AI model for identifying predicted high-cost claimants in accordance with an illustrative embodiment. Operation begins (block 500), and the mechanism trains a machine learning (ML) model with a combination of de-identified claims data and customized client data (block 501). The mechanism then performs transfer learning on the customized client data by retraining the common model (block 502). The common model is the AI model trained using cross-tenant de-identified data. The mechanism applies the resulting ML model on the customized client data to predict high-cost clients (HCCs) (block 503).

Next, the mechanism generates association rules (block 504) and recommends top measures that make a high-cost claimants no longer high-cost, ranked by confidence score (block 505). Thereafter, operation ends (block 506).

FIG. 6 is a flowchart illustrating operation of a mechanism for performing prescriptive analytics to generate recommendations to reduce healthcare costs in accordance with an illustrative embodiment. Operation begins (block 600), and the mechanism applies FP-Growth to find the frequent common features among all predicted HCCs (block 601). The mechanism filters historical de-identified data for individuals with identified features (block 602). Then, the mechanism applies association rule mining to find the rule: X→Y, where X is the set of measures and Y indicates that the individuals are no longer HCCs (block 603).

The mechanism then applies the rules to the customized client data to generate recommendations with confidence values (block 604). The mechanism ranks the recommendations by confidence value and outputs the top K recommendations (block 604) with confidence scores. Thereafter, operation ends (block 605).

Consider the following example of prescriptive analytics results for 10,000 patients with 1,600 predicted HCCs and common features of E1165 Type 2 diabetes mellitus with hyperglycemia (frequent features identified by FP-growth). The top recommendations are as follows:
82043 Albumin; urine (e.g., microalbumin), quantitative, conf 0.2381
82570 Creatinine; other source, conf 0.2273
36415 Collection of venous blood by venipuncture, conf 0.2139
83036 Hemoglobin; glycosylated (AIC), conf0.2063
80061 Lipid panel This panel must include the following: Cholesterol, serum, total (82465) Lipoprotein, direct measurement, high density cholesterol (HDL cholesterol) (83718) Triglycerides (84478), conf 0.2049
I10 Essential (primary) hypertension, conf 0.2005
80053 Comprehensive metabolic panel This panel must include the following: Albumin (82040) Bilirubin, total (82247) Calcium, total (82310) Carbon dioxide (bicarbonate) (82374) Chloride (82435) Creatinine (82565) Glucose (82947) Phosphatase, alkaline (84075), conf 0.1939
85025 Blood count; complete (CBC), automated (Hgb, Hct, RBC, WBC and platelet count) and automated differential WBC count, conf 0.1752
E782 Mixed hyperlipidemia, conf 0.1625

Also consider for the 1,600 predicted HCCs and filtering for female age 18 to 65. Two of the top three recommended results were types of mammography, with high confidence scores. The rest of the results were general examinations and lab work.

Thus, the illustrative embodiments provide mechanisms for not only predicting likely future high-cost claimants but also generating prescriptive recommendations for preventing members from becoming high-cost claimants. The illustrative embodiments provide healthcare recommendations or early interventions (e.g., procedures, drugs, rehabilitation, and measures) to individuals who are predicted to be HCCs to reduce healthcare cost to employers as well as insurance companies.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a communication bus, such as a system bus, for example. The memory elements can include local memory employed during actual execution of the program code, bulk storage, and cache memories which provide temporary storage of at least some program code in order to reduce the number of times code must be retrieved from bulk storage during execution. The memory may be of various types including, but not limited to, ROM, PROM, EPROM, EEPROM, DRAM, SRAM, Flash memory, solid state memory, and the like.

Input/output or I/O devices (including but not limited to keyboards, displays, pointing devices, etc.) can be coupled to the system either directly or through intervening wired or wireless I/O interfaces and/or controllers, or the like. I/O devices may take many different forms other than conventional keyboards, displays, pointing devices, and the like, such as for example communication devices coupled through wired or wireless connections including, but not limited to, smart phones, tablet computers, touch screen devices, voice recognition devices, and the like. Any known or later developed I/O device is intended to be within the scope of the illustrative embodiments.

Network adapters may also be coupled to the system to enable the data processing system to become coupled to other data processing systems or remote printers or storage devices through intervening private or public networks. Modems, cable modems and Ethernet cards are just a few of the currently available types of network adapters for wired communications. Wireless communication based network adapters may also be utilized including, but not limited to, 802.11 a/b/g/n wireless communication adapters, Bluetooth wireless adapters, and the like. Any known or later developed network adapters are intended to be within the spirit and scope of the present invention.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, in a data processing system, for predictive and prescriptive analytics for managing high-cost claimants, the method comprising:
training a machine learning model using the set of de-identified claims data to predict high-cost claimants using the training data;
applying transfer learning by retraining the machine learning model using a first set of customized client data to generate a client-specific machine learning model;
applying the client-specific machine learning model to a second set of customized client data to identify a set of predicted high-cost claimants within the second set of customized client data;
generating association rules for determining recommendations for preventing the set of predicted high-cost claimants from becoming high-cost claimants; and
applying the association rules to the second set of customized client data to generate a set of recommendations.

2. The method of claim 1, wherein generating the association rules comprises:
finding frequent common features among the set of predicted high-cost claimants;
filtering the de-identified claims data for individuals having the frequent common features; and
applying association rule mining on the filtered de-identified claims data to generate a set of association rules, wherein each rule in the set of association rule associates a measure with an individual who is no longer a high-cost claimant.

3. The method of claim 2, wherein the measure comprises a procedure, a drug, or a rehabilitation measure.

4. The method of claim 2, wherein generating the association rules further comprises generating a confidence value for each measure and ranking the measures by confidence value.

5. The method of claim 4, wherein applying the association rules to the second set of customized client data comprises outputting a predetermined number of recommendations with the highest confidence value.

6. The method of claim 1, wherein generating the association rules comprises applying a Frequent Pattern (FP) Growth algorithm to the second set of customized client data.

7. The method of claim 1, wherein the machine learning model comprises a bidirectional Recurrent Neural Network with attention.

8. A computer program product comprising a computer readable storage medium having a computer readable program stored therein, wherein the computer readable program, when executed on a computing device, causes the computing device to:
train a machine learning model using the set of de-identified claims data to predict high-cost claimants using the training data;
apply transfer learning by retraining the machine learning model using a first set of customized client data to generate a client-specific machine learning model;
apply the client-specific machine learning model to a second set of customized client data to identify a set of predicted high-cost claimants within the second set of customized client data;
generate association rules for determining recommendations for preventing the set of predicted high-cost claimants from becoming high-cost claimants; and
apply the association rules to the second set of customized client data to generate a set of recommendations.

9. The computer program product of claim 8, wherein generating the association rules comprises:
finding frequent common features among the set of predicted high-cost claimants;
filtering the de-identified claims data for individuals having the frequent common features; and
applying association rule mining on the filtered de-identified claims data to generate a set of association rules, wherein each rule in the set of association rule associates a measure with an individual who is no longer a high-cost claimant.

10. The computer program product of claim 9, wherein the measure comprises a procedure, a drug, or a rehabilitation measure.

11. The computer program product of claim 9, wherein generating the association rules further comprises generating a confidence value for each measure and ranking the measures by confidence value.

12. The computer program product of claim 11, wherein applying the association rules to the second set of customized client data comprises outputting a predetermined number of recommendations with the highest confidence value.

13. The computer program product of claim 8, wherein generating the association rules comprises applying a Frequent Pattern (FP) Growth algorithm to the second set of customized client data.

14. The computer program product of claim 8, wherein the machine learning model comprises a bidirectional Recurrent Neural Network with attention.

15. An apparatus comprising:
a processor; and
a memory coupled to the processor, wherein the memory comprises instructions which, when executed by the processor, cause the processor to:
train a machine learning model using the set of de-identified claims data to predict high-cost claimants using the training data;
apply transfer learning by retraining the machine learning model using a first set of customized client data to generate a client-specific machine learning model;
apply the client-specific machine learning model to a second set of customized client data to identify a set of predicted high-cost claimants within the second set of customized client data;
generate association rules for determining recommendations for preventing the set of predicted high-cost claimants from becoming high-cost claimants; and
apply the association rules to the second set of customized client data to generate a set of recommendations.

16. The apparatus of claim 15, wherein generating the association rules comprises:
finding frequent common features among the set of predicted high-cost claimants;
filtering the de-identified claims data for individuals having the frequent common features; and
applying association rule mining on the filtered de-identified claims data to generate a set of association rules, wherein each rule in the set of association rule associates a measure with an individual who is no longer a high-cost claimant.

17. The apparatus of claim 16, wherein the measure comprises a procedure, a drug, or a rehabilitation measure.

18. The apparatus of claim 16, wherein generating the association rules further comprises generating a confidence value for each measure and ranking the measures by confidence value.

19. The apparatus of claim 15, wherein generating the association rules comprises applying a Frequent Pattern (FP) Growth algorithm to the second set of customized client data.

20. The apparatus of claim 15, wherein the machine learning model comprises a bidirectional Recurrent Neural Network with attention.
